(19) United States
(12) Patent Application Publication
(10) Pub. No.: US 2016/0134486 A1
(43) Pub. Date: May 12, 2016

(54) SYSTEMS, METHODS, AND MEDIA FOR PRESENTING METRIC DATA

(71) Applicants: Itamar Haber, Rehovot (IL); Orian Sandstein, Gan Hayim (IL); Ofer Bengal, Tel-Aviv (IL); Yiftach M. Shoolman, Modi'in (IL)

(72) Inventors: Itamar Haber, Rehovot (IL); Orian Sandstein, Gan Hayim (IL); Ofer Bengal, Tel-Aviv (IL); Yiftach M. Shoolman, Modi'in (IL)

(21) Appl. No.: 14/536,351

(22) Filed: Nov. 7, 2014

(51) Int. Cl. H04L 12/24; G06F 3/0484; G06F 3/0482

(52) U.S. Cl. CPC H04L 41/22; G06F 3/0482; G06F 3/04842

(57) ABSTRACT

In some embodiments, presenting metric data comprises: using one or more hardware processors to: cause a display to present a first set of smaller representations of metrics, wherein each of the smaller representations in the first set corresponds to a unique metric; receive a first selection of one of the smaller representations from the first set; cause a display to present a second set of smaller representations of metrics, wherein each of the smaller representations in the second set corresponds to a unique component and corresponds to the unique metric corresponding to the first selection; receive a second selection of one of the smaller representations from the second set; cause a display to present the second selection in a first larger representation; receive a third selection of one of the smaller representations from the second set; and cause a display to present the third selection in a second larger representation.

### TECHNICAL FIELD

The disclosed subject matter relates to systems, methods, and media for presenting metric data.

### BACKGROUND

When viewing metrics corresponding to data generated by systems, it is desirable to be able to view a large number of metrics simultaneously and then focus in on a smaller number of metrics and view them in more detail. Existing mechanisms for presenting metrics are insufficient.

Accordingly, new systems, methods, and media for presenting metric data are desirable.

### SUMMARY

Systems, methods, and media for presenting metric data are provided. In accordance with some embodiments, methods for presenting metric data are provided, the methods comprising: using one or more hardware processors to: cause a display to present a first set of smaller representations of metrics, wherein each of the smaller representations in the first set corresponds to a unique metric; receive a first selection of one of the smaller representations from the first set; cause a display to present a second set of smaller representations of metrics, wherein each of the smaller representations in the second set corresponds to a unique component and corresponds to the unique metric corresponding to the first selection; receive a second selection of one of the smaller representations from the second set; cause a display to present the second selection in a first larger representation; receive a third selection of one of the smaller representations from the second set; and cause a display to present the third selection in a second larger representation.

In accordance with some embodiments, methods for presenting metric data are provided, the methods comprising: using one or more hardware processors to: cause a display to present a first set of smaller representations of metrics, wherein each of the smaller representations in the first set corresponds to a unique component; receive a first selection of one of the smaller representations from the first set; cause a display to present a second set of smaller representations of metrics, wherein each of the smaller representations in the second set corresponds to a unique metric and corresponds to the unique component corresponding to the first selection; receive a second selection of one of the smaller representations from the second set; cause a display to present the second selection in a first larger representation; receive a third selection of one of the smaller representations from the second set; and cause a display to present the third selection in a second larger representation.

In accordance with some embodiments, methods for presenting metric data are provided, the methods comprising: using one or more hardware processors to: cause a display to present a first set of smaller representations of metrics, wherein each of the smaller representations in the first set corresponds to a unique component; receive a first selection of one of the smaller representations from the first set; cause a display to present a second set of smaller representations of metrics, wherein each of the smaller representations in the second set corresponds to a unique metric and corresponds to the unique component corresponding to the first selection; receive a second selection of one of the smaller representations from the second set; cause a display to present the second selection in a first larger representation; receive a third selection of one of the smaller representations from the first set; cause a display to re-present the second set of smaller representations of metrics, wherein each of the smaller representations in the re-presentation of the second set corresponds to a unique metric and corresponds to the unique component corresponding to the third selection; receive a fourth selection of one of the smaller representations from the re-presentation of the second set; and cause a display to present the fourth selection in a second larger representation.

In accordance with some embodiments, methods for presenting metric data are provided, the methods comprising: using one or more hardware processors to: cause a display to present a first set of smaller representations of metrics, wherein each of the smaller representations in the first set corresponds to a unique metric; receive a first selection of one of the smaller representations from the first set; cause a display to present a second set of smaller representations of metrics, wherein each of the smaller representations in the second set corresponds to a unique component and corresponds to the unique metric corresponding to the first selection; receive a second selection of one of the smaller representations from the second set; cause a display to present the second selection in a first larger representation; receive a third selection of one of the smaller representations from the first set; cause a display to re-present the second set of smaller representations of metrics, wherein each of the smaller representations in the re-presentation of the second set corresponds to a unique component and corresponds to the unique metric corresponding to the third selection; receive a fourth selection of one of the smaller representations from the re-presentation of the second set; and cause a display to present the fourth selection in a second larger representation.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 is a block diagram of system hardware that can be used in some embodiments.

FIG. 2 is a block diagram of hardware that can be used to implement one or more components of FIG. 1 in some embodiments.

FIG. 3 is an example of a user interface that can be provided in accordance with some embodiments.

FIG. 4 is another example of a user interface that can be provided in accordance with some embodiments.

FIG. 5 is still another example of a user interface that can be provided in accordance with some embodiments.

FIG. 6 is a flow diagram of an example of a process that can be used in some embodiments.

### DETAILED DESCRIPTION

In accordance with various embodiments, as described in more detail below, mechanisms, which can include systems, methods, and computer-readable media, for presenting metrics corresponding to data are provided.

As described further herein, these mechanisms can be used to present a graphical user interface in which one or more large representations of metrics corresponding to data are provided along with a plurality of smaller representations of metrics corresponding to data. Although the term large is used to describe some of the representations of metrics, this term should not be construed as having any absolute size. Rather this term is simply intended to convey that the large representations are larger than the smaller representations. In some embodiments, the large representations are presented with a higher resolution than the smaller representations.

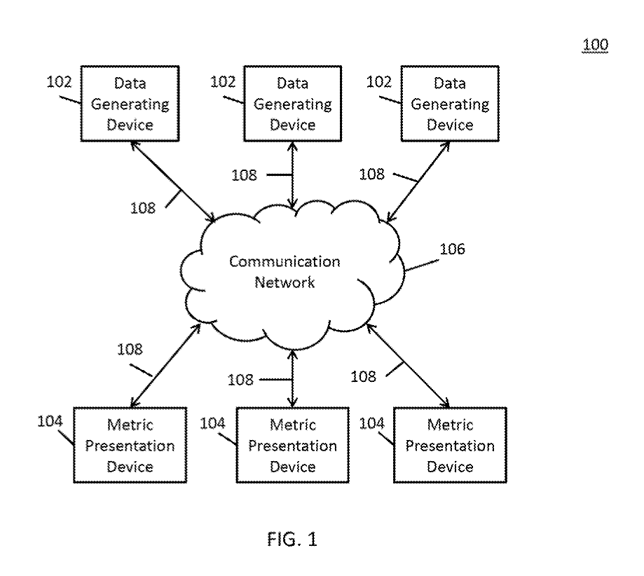

Turning to FIG. 1, an example of system hardware 100 that can be used in some embodiments is illustrated. As shown, system hardware 100 can include one or more data generating devices 102, one or more metric presentation devices 104, a communication network 106, communication links 108, and/or any other suitable components.

Data generating devices 102 can be any suitable devices that generate data corresponding to metrics to be presented. For example, in some embodiments, data generating devices can be servers, databases, workstations, storage devices, routers, switches, modems, computers, load balancers, and/or any other suitable devices.

Metric presentation devices 104 can be any suitable devices that can present representations of metrics corresponding to the data generated by the data generating devices. For example, in some embodiments, metric presentation devices can be mobile phones, a tablet computers, wearable computers, laptop computers, desktop computers, personal data assistants (PDAs), portable email devices, servers, data appliances, workstations, and/or any other suitable devices.

In some embodiments, each of data generating devices 102 and metric presentation devices 104 can be implemented as a stand-alone device or integrated with one or more other components of hardware 100 and/or any other suitable device(s). In some embodiments, a device can be both a data generating device 102 and a metric presentation device 104.

Although three data generating devices 102 and three metric presentation devices 104 are shown in FIG. 1, any suitable number of each of these devices can be provided in some embodiments. For example, in some embodiments, one of each device can be provided. As another example, in some embodiments, a device 102 and a device 104 may each make up part of a single physical device.

Communication network 106 can be any suitable computer network such as the Internet, an intranet, a wide-area network (“WAN”), a local-area network (“LAN”), a wireless network, a digital subscriber line (“DSL”) network, a frame relay network, an asynchronous transfer mode (“ATM”) network, a virtual private network (“VPN”), a satellite network, a mobile phone network, a mobile data network, a cable network, a telephone network, a fiber optic network, and/or any other suitable communication network, or any combination of any of such networks.

In some embodiments, data generating devices 102 and metric presentation devices 104 can be connected to communication network 106 through communication links 108. In some embodiments, communication links 108 can be any suitable communication links, such as network links, dial-up links, wireless links, hard-wired links, any other suitable communication links, or a combination of such links.

In some embodiments, communication network 106 and communication links 108 can be omitted when not needed.

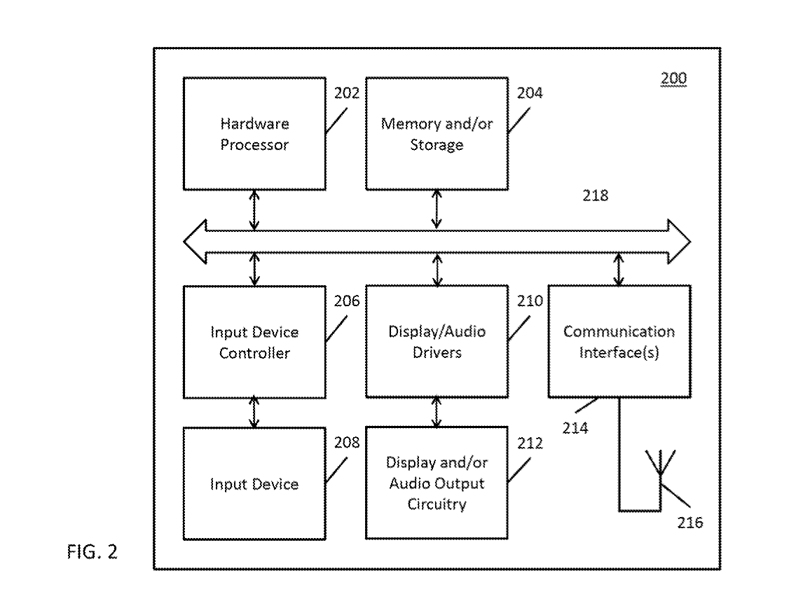

Each of devices 102 and 104 can include and/or be any of a general purpose device such as a computer or a special purpose device such as a client, a server, and/or any other suitable device. Any such general purpose computer or special purpose computer can include any suitable hardware. For example, as illustrated in example hardware 200 of FIG. 2, such hardware can include a hardware processor 202, memory and/or storage 204, an input device controller 206, an input device 208, display/audio drivers 210, display and/or audio output circuitry 212, communication interface(s) 214, an antenna 216, and a bus 218.

Hardware processor 202 can include any suitable hardware processor, such as a microprocessor, a micro-controller, digital signal processor, dedicated logic, and/or any other suitable circuitry for controlling the functioning of a general purpose computer or special purpose computer in some embodiments.

Memory and/or storage 204 can be any suitable memory and/or storage for storing programs, data, metrics, and/or any other suitable information in some embodiments. For example, memory and/or storage 204 can include random access memory, read only memory, flash memory, hard disk storage, optical media, and/or any other suitable storage device.

Input device controller 206 can be any suitable circuitry for controlling and receiving input from one or more input devices 208 in some embodiments. For example, input device controller 206 can be circuitry for receiving input from a touch screen, from one or more buttons, from a voice recognition circuit, from a microphone, from a camera, from an optical sensor, from an accelerometer, from a temperature sensor, from a near field sensor, and/or any other suitable circuitry for receiving user input.

Display/audio drivers 210 can be any suitable circuitry for controlling and driving output to one or more display and/or audio output circuitries 212 in some embodiments. For example, display/audio drivers 210 can be circuitry for driving an LCD display, a speaker, an LED, and/or any other display/audio device.

Communication interface(s) 214 can be any suitable circuitry for interfacing with one or more communication networks, such as communication network 106 in some embodiments. For example, interface(s) 214 can include network interface card circuitry, wireless communication circuitry, and/or any other suitable circuitry for interfacing with one or more communication networks.

Antenna 216 can be any suitable one or more antennas for wirelessly communicating with a communication network in some embodiments. In some embodiments, antenna 216 can be omitted when not needed.

Bus 218 can be any suitable mechanism for communicating between two or more of components 202, 204, 206, 210, and 214 in some embodiments.

Any other suitable components can be included in hardware 200 in accordance with some embodiments.

In some embodiments, any suitable computer readable media can be used for storing instructions for performing the processes described herein. For example, in some embodiments, computer readable media can be transitory or non-transitory. For example, non-transitory computer readable media can include media such as magnetic media (such as hard disks, floppy disks, and/or any other suitable media), optical media (such as compact discs, digital video discs, Blu-ray discs, and/or any other suitable optical media), semiconductor media (such as flash memory, electrically programmable read only memory (EPROM), electrically erasable programmable read only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

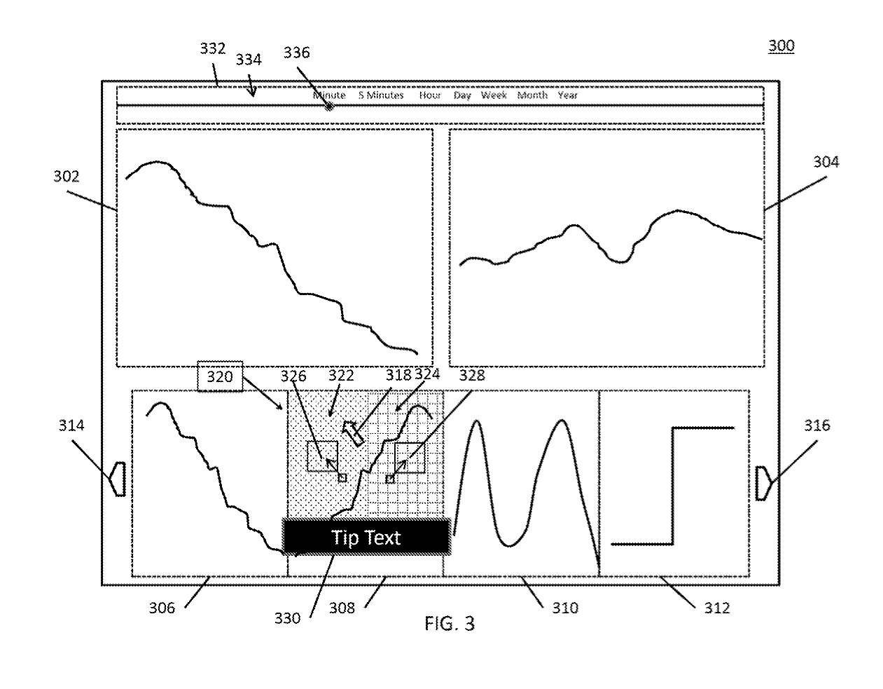

Turning to FIG. 3, an example 300 of graphical user interface that can be generated and presented in accordance with some embodiments is shown.

As illustrated, interface 300 includes two large representations 302 and 304 of metrics corresponding to data and four smaller representations 306, 308, 310, and 312 of metrics corresponding to data. Although two large representations 302 and 304 and four smaller representations 306, 308, 310, and 312 are shown, any suitable number of large representations and any suitable number of smaller representations can be provided.

In some embodiments, a user may be able to be presented with additional smaller representations of metrics corresponding to data in response to selecting left arrow 314 or right arrow 316. In response to the user selecting one of these (e.g., by clicking on one of the arrows using a computer mouse), the smaller representations may scroll in the direction that the arrow is pointing to reveal an additional smaller representation. This scrolling may continue in a virtual loop of the smaller representations, or only a given number of additional smaller representations may be presentable by selecting arrows 314 and 316.

As shown, representation 302, 304, 306, 308, 310, and 312 can be used to show graphical representations of metrics corresponding to data. Additionally or alternatively, any other suitable information can be shown, and the information can be shown in any suitable manner. For example, instead of presenting the information graphically, the information can be presented as texts, number, symbols, characters, and/or any other suitable visual objects. As another example, information can be presented in tables, columns, rows, paragraphs, lines, and/or in any other suitable arrangement.

As shown in smaller representation 308, upon a user positioning a cursor 318 over representation 308, representation can be overlaid with an enlarge representation indicator (ERI) 320 including one or more of two regions 322 and 324, icons 326 and 328, and tip text 330.

Although regions 322 and 324 are shown using patterns for the purpose of illustration, and suitable mechanism can be used to split representation 308 into two parts. For example, a simple line can be presented down the middle of representation 308.

Icons 326 and 328 can be any suitable icons, symbols, numbers, letters, and/or visual objects usable to indicate to a user that, upon selecting one of the icons and/or its corresponding region, the smaller representation will be presented in one of the large representation(s) displayed on the interface. More particularly, icon 326 can be used to represent that, upon selecting it and/or region 322, smaller representation 308 will be presented in large representation 302. Similarly, icon 328 can be used to represent that, upon selecting it and/or region 324, smaller representation 308 will be presented in large representation 304.

As used herein, “selecting” can include any suitable way of choosing an element of a user interface. For example, selecting can include point a cursor at an element using a computer mouse and clicking on a button on the mouse. As another example, selecting can include touching an element presented on a display having a touch-sensitive interface.

Tip text 330 can be any suitable text to advise a user as to how to cause a smaller representation to be presented as a large representation. For example, tip text 330 can state “select the left icon to move this to the left pane or the right icon to move this to the right pane.”

As shown in region 332, interface 300 can also include a scale control 334 in some embodiments. As illustrated, scale control 334 can be used to select a time scale at which the representations are presented. For example, units along the X-axis on the graphs shown in the large and smaller representations can be set at a minute scale, as shown by indicator 336, or a five-minute scale, an hour scale, a day scale, a week scale, a month scale, a year scale, and/or at any other suitable scale or combination scales.

Although scale control 334 is shown as being time based, this control can be based on any other suitable scale based on any other suitable reference. For example, the scale can be based on a voltage, a unit of power (e.g., Watt), current, dollars, and/or any other suitable scale.

Although scale control 334 is described herein as being associated with the X-axis of the representations in interface 300, scale control 334 can alternatively be associated with any other reference. For example, in some embodiments, the scale control can be associated with the Y-axis, with a Z-axis (not shown), and/or with any other suitable axis or reference.

Although only one scale control 334 is shown in FIG. 3, any suitable number of scale controls can be provided in some embodiments. For example, in some embodiments, another scale control can be provided for the Y-axis of the representations shown in FIG. 3.

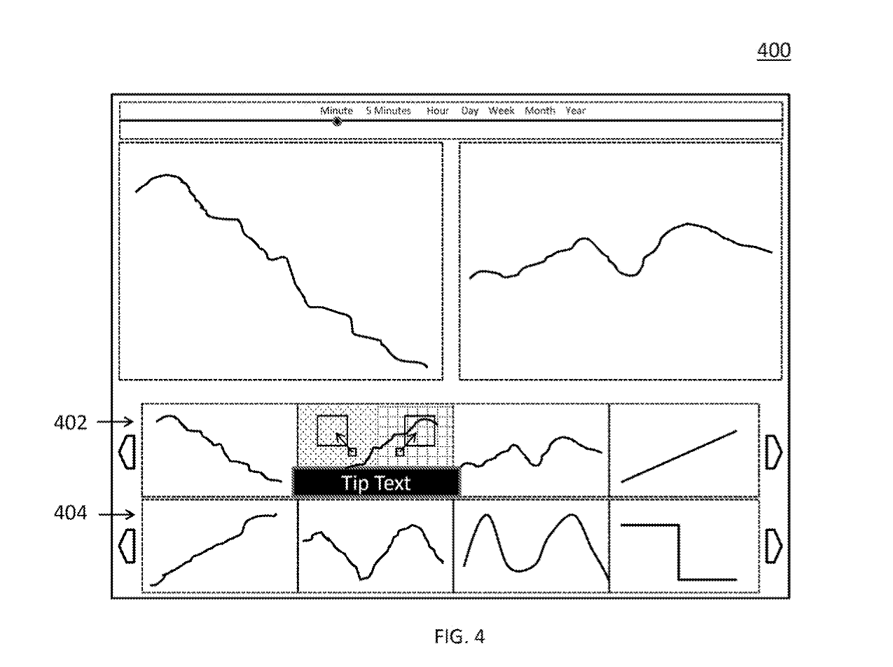

In some embodiments, multiple sets of smaller representations can be provided as shown in interface 400 of FIG. 4. As illustrated, these sets of smaller representations can be shown in rows 402 and 404. Any suitable number of sets of smaller representations, each including any suitable number of smaller representations, can be provided in an interface in accordance with some embodiments. In some embodiments, different sets of smaller representations can correspond to metrics from different components, systems, subsystems, and/or any other suitable portion of one or more sources of data. In some embodiments, the metrics presented in each of the smaller representations can be arranged so that the same metrics for two different components, systems, subsystems, etc. are aligned in columns on the two rows shown in interface 400.

In some embodiments, a first set of smaller representations can be used to represent one feature of a system and a second set of smaller representations can be used to represent related features of a feature selected from the first set. For example, in some embodiments, the first set can represent components of a system, such as a server, a database shard, a hardware processor, memory, a disk drive, a networking component, etc. For a selected smaller representation of the first set, the second set of smaller representations can present any suitable metrics. For example, the metrics can include CPU utilization, memory usage, disk usage, throughput, latency, disk access wait time, etc. More particularly, for example, upon selecting a particular server in the first set, the user can be presented with a second set of representations that show all metrics related to that particular server. The user can then select one or more of those metrics to be presented in the larger representations using an ERI as described above.

Although the representations in the second set are described above as being based on a selection from the first set, the representations shown in the first set can be responsive to a selection in the second set in some embodiment. For example, if the first set corresponds to components, and the second set corresponds to metrics, upon selecting a metric from the second set, that metric can be presented for each component in the second set. More particularly, for example, upon selecting a CPU utilization metric from the second set, the CPU utilizations for each component (such as servers) in the first set of small representations can be presented.

In some embodiments, the first set and the second set can be responsive to the last selection made in the second set and first set, respectively. In this way, the presentations of the two sets can be interdependent.

Although only two sets are described in this paragraph, any suitable number of sets of smaller representations of features and related features can be provided, and those one or more of those sets can be responsive to one of more of the other of those sets.

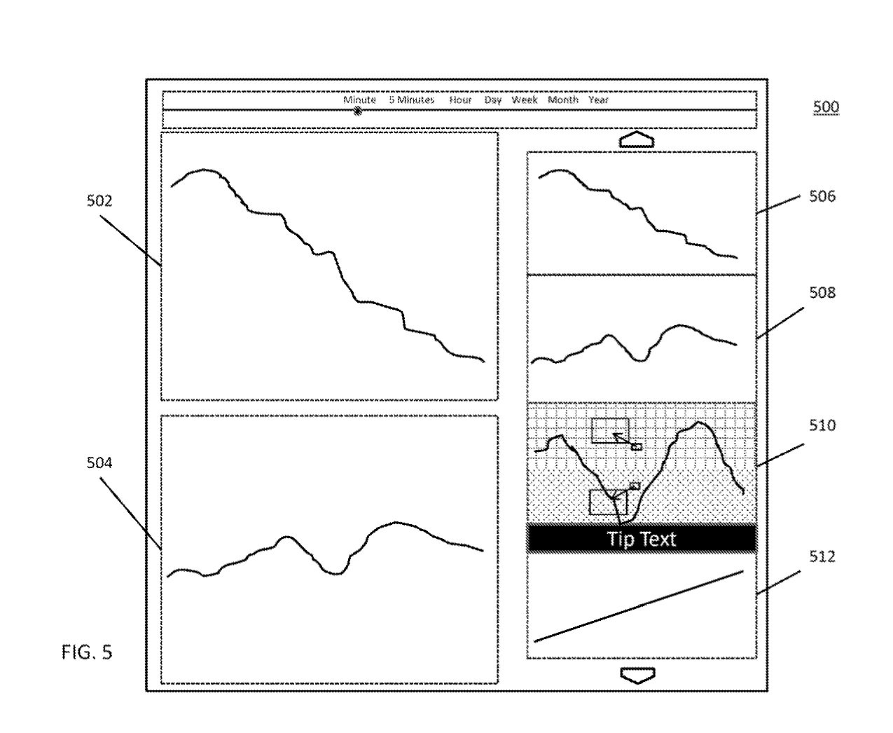

Turning to FIG. 5, another example 500 of a graphical user interface that can be presented in accordance with some embodiments is shown. As illustrated, two large representations 502 and 504 are shown in a vertical alignment on the left portion of interface 500 and smaller representations 506, 508, 510, and 512 are shown in a vertical alignment on the right portion of interface 500. As is clear from FIGS. 3, 4, and 5, any suitable combination of number, arrangement, layout, etc. of large representations and smaller representations (and sets of smaller representations) can be provided in some embodiments.

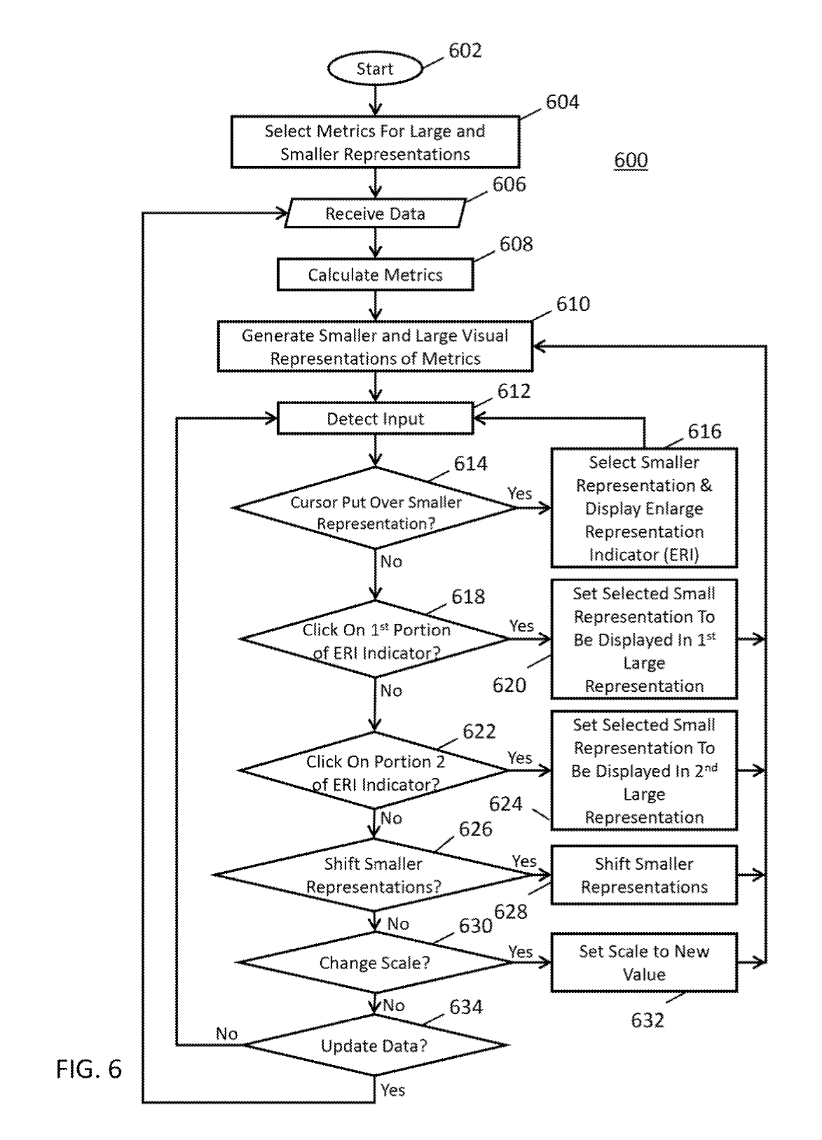

FIG. 6 shows a flow diagram of an example 600 of a process that can be used to present metrics in accordance with some embodiments. As illustrated, after process 600 begins at 602, the process can select metrics for the large representations and the smaller representations. Any suitable metrics can be selected and for any suitable reason. For example, in some embodiments, the two most important metrics (e.g., based on feedback from users) can be selected for presentation in the large representations, and the next four most important metrics can be selected for presentation in the smaller representations.

Next, at 606, any suitable data for use in the metrics can be received in any suitable manner and from any suitable source. For example, this data may be received at a device 104 from a device 102 via communication network 106 and links 108 using communication interfaces 214.

At 608, the metrics for representation in the large and smaller representations can be calculated. Any suitable metrics can be calculated from any suitable data, and in any suitable manner.

Smaller representations and large representations of the visual metrics can next be generated. The representations can be generated in any suitable manner. For example, the metrics can be generated as two-dimensional graphs.

At 612, process 600 can detect user input. User input can be detected in any suitable manner and from any suitable source. For example, in some embodiments, the user input can be detected from any suitable input device, such as an input device 208.

Process 600 can then determine whether a cursor indicated by the user input was just put over a smaller representation at 614. If process 600 determines at 614 that a cursor was just put over a smaller representation, the process can next select the smaller representation and display an enlarge representation indicator (ERI) at 616, and then loop back to 612. Any suitable enlarge representation indicator can be presented and the enlarge representation indicator can be presented in any suitable manner. For example, the ERI can be presented as shown and described in connection with FIG. 3.

At 618, the process can determine if the user clicked on a first portion of a previously presented ERI. The first portion of the ERI can be any suitable portion of the ERI. For example, as illustrated in FIG. 3, the first portion of the ERI can be region 322 and/or icon 326. If, at 618, process 600 determines that the user clicked on a first portion of the ERI, process 600 can next set the selected smaller representation (i.e., the smaller representation with the ERI over it) to be displayed in the first large representation and then loop back to 610. Any suitable large representation can be the first large representation. For example, in some embodiments, the left large representation of FIG. 3 (i.e., representation 302) can be the first large representation.

At 622, the process can determine if the user clicked on a second portion of the previously presented ERI. The second portion of the ERI can be any suitable portion of the ERI. For example, as illustrated in FIG. 3, the second portion of the ERI can be region 324 and/or icon 328. If, at 622, process 600 determines that the user clicked on a second portion of the ERI, process 600 can next set the selected smaller representation (i.e., the smaller representation with the ERI over it) to be displayed in the second large representation and then loop back to 610. Any suitable large representation can be the second large representation. For example, in some embodiments, the right large representation of FIG. 3 (i.e., representation 304) can be the second large representation.

At 626, process 600 can determine whether to shift the smaller representations. This determination can be made in any suitable manner. For example, process 600 can determine whether to shift the smaller representations based on whether the user has selected one of arrows 314 and 316 of FIG. 3. If it is determined at 626 to shift the smaller representations, process 600 can shift the smaller representations at 628 and then loop back to 610. The smaller representations can be shifted in any suitable manner, such as the manner described above in connection with FIG. 3.

At 630, process 600 can determine whether to change the scale of the representations. This determination can be made in any suitable manner. For example, this determination can be made based on whether a user has selected to change the scale using as scale indicator 334 as shown in, and described in connection with, FIG. 3. If it is determined at 630 to change the scale, process 600 can change the scale at 632 in any suitable manner and then loop back to 610.

At 634, process 600 can determine whether to update the data on which the metrics are based. This determination can be made in any suitable manner based on any suitable criteria or criterion. If it is determined at 634 to update the data, process 600 can loop back to 606. Otherwise, process 600 can loop back to 612.

Process 600 can be executed as software running on a hardware processor of any suitable one or more devices. For example, process 600 can be executed at least in part by a hardware processor of a device 102, a device 104, and/or any other suitable device (e.g., a device not shown in FIG. 1). As a more particular example, process 600 can be executed in part on a Web server that generates Web pages with user interfaces (e.g., such as interface 300) therein and delivers those Web pages to one or more of devices 104. Such a Web server can be implemented in a dedicated Web server or in one of devices 102.

It should be noted that the above steps of the flow diagram of FIG. 6 can be executed or performed in any order or sequence not limited to the order and sequence shown and described in the figure. Also, some of the above steps of the flow diagram of FIG. 6 can be executed or performed substantially simultaneously where appropriate or in parallel to reduce latency and processing times. Furthermore, it should be noted that FIG. 6 is provided as an example only. At least some of the steps shown in this figure may be performed in a different order than represented, performed concurrently, or altogether omitted.

The provision of the examples described herein (as well as clauses phrased as “such as,” “e.g.,” “including,” and the like) should not be interpreted as limiting the claimed subject matter to the specific examples; rather, the examples are intended to illustrate only some of many possible aspects.

Accordingly, systems, methods, and media for presenting metrics are provided.

Although the disclosed subject matter has been described and illustrated in the foregoing illustrative embodiments, the present disclosure has been made only by way of example, and numerous changes in the details of implementation of the disclosed subject matter can be made without departing from the spirit and scope of the disclosed subject matter, which is limited only by the claims that follow. Features of the disclosed embodiments can be combined and rearranged in various ways.

What is claimed is:

1. A method of presenting metric data, comprising using one or more hardware processors to:
cause a display to present a first set of smaller representations of metrics, wherein each of the smaller representations in the first set corresponds to a unique metric;
receive a first selection of one of the smaller representations from the first set;
cause a display to present a second set of smaller representations of metrics, wherein each of the smaller representations in the second set corresponds to a unique component and corresponds to the unique metric corresponding to the first selection;
receive a second selection of one of the smaller representations from the second set;
cause a display to present the second selection in a first larger representation;
receive a third selection of one of the smaller representations from the second set; and
cause a display to present the third selection in a second larger representation.

2. The method of claim 1, wherein the first selection corresponds to one of CPU utilization and memory usage.

3. The method of claim 1, wherein the second selection corresponds to one of a server, a storage device, a network switch, a firewall, and a load balancer.

4. A method of presenting metric data, comprising
using one or more hardware processors to:
cause a display to present a first set of smaller representations of metrics, wherein each of the smaller representations in the first set corresponds to a unique component;
receive a first selection of one of the smaller representations from the first set;
cause a display to present a second set of smaller representations of metrics,
wherein each of the smaller representations in the second set corresponds to a unique metric and corresponds to the unique component corresponding to the first selection;
receive a second selection of one of the smaller representations from the second set;
cause a display to present the second selection in a first larger representation;
receive a third selection of one of the smaller representations from the second set; and
cause a display to present the third selection in a second larger representation.

5. The method of claim 4, wherein the first selection corresponds to one of a server, a storage device, a network switch, a firewall, and a load balancer.

6. The method of claim 4, wherein the second selection corresponds to one of CPU utilization and memory usage.

7. A method of presenting metric data, comprising
using one or more hardware processors to:
cause a display to present a first set of smaller representations of metrics, wherein each of the smaller representations in the first set corresponds to a unique component;
receive a first selection of one of the smaller representations from the first set;
cause a display to present a second set of smaller representations of metrics, wherein each of the smaller representations in the second set corresponds to a unique metric and corresponds to the unique component corresponding to the first selection;
receive a second selection of one of the smaller representations from the second set;
cause a display to present the second selection in a first larger representation;
receive a third selection of one of the smaller representations from the first set;
cause a display to re-present the second set of smaller representations of metrics,
wherein each of the smaller representations in the re-presentation of the second set corresponds to a unique metric and corresponds to the unique component corresponding to the third selection;
receive a fourth selection of one of the smaller representations from the re-presentation of the second set; and
cause a display to present the fourth selection in a second larger representation.

8. The method of claim 7, wherein the first selection corresponds to one of a server, a storage device, a network switch, a firewall, and a load balancer.

9. The method of claim 7, wherein the second selection corresponds to one of CPU utilization and memory usage.

10. A method of presenting metric data, comprising
using one or more hardware processors to:
cause a display to present a first set of smaller representations of metrics, wherein each of the smaller representations in the first set corresponds to a unique metric;
receive a first selection of one of the smaller representations from the first set;
cause a display to present a second set of smaller representations of metrics, wherein each of the smaller representations in the second set corresponds to a unique component and corresponds to the unique metric corresponding to the first selection;
receive a second selection of one of the smaller representations from the second set;
cause a display to present the second selection in a first larger representation;
receive a third selection of one of the smaller representations from the first set;
cause a display to re-present the second set of smaller representations of metrics,
wherein each of the smaller representations in the re-presentation of the second set corresponds to a unique component and corresponds to the unique metric corresponding to the third selection;
receive a fourth selection of one of the smaller representations from the re-presentation of the second set; and
cause a display to present the fourth selection in a second larger representation.

11. The method of claim 10, wherein the first selection corresponds to one of CPU utilization and memory usage.

12. The method of claim 10, wherein the second selection corresponds to one of a server, a storage device, a network switch, a firewall, and a load balancer.
